(19) United States
(12) Patent Application Publication
(10) Pub. No.: US 2018/0060993 A1
(43) Pub. Date: Mar. 1, 2018

(54) SYSTEM AND METHOD FOR DIGITIZING SAMPLES UNDER A MICROSCOPE

(71) Applicant: SIGTUPLE TECHNOLOGIES PRIVATE LIMITED, Bengaluru (IN)

(72) Inventors: BHARATH CHELUVARAJU, Bengaluru (IN); ROHIT KUMAR PANDEY, Bengaluru (IN); APURV ANAND, Bengaluru (IN); TATHAGATO RAI DASTIDAR, Bengalore (IN)

(21) Appl. No.: 15/508,459

(22) PCT Filed: Oct. 3, 2016
(86) PCT No.: PCT/IN2016/000240

§ 371 Date: Mar. 2, 2017

(30) Foreign Application Priority Data
Feb. 23, 2016 (IN) 201641006265

(51) Int. Cl. G06T 1/00; G02B 21/36; G06F 19/00

(52) U.S. Cl. CPC G06T 1/0014; G06T 1/0007; G06K 9/00; G06F 19/366; G02B 21/36

(57) ABSTRACT

The embodiments herein provides a system and method for capturing images or videos observed through a microscope by focusing the image and selecting the appropriate field of view using a smart computing device or any device with a camera capable of capturing images or videos, being programmed and configured to communicate with at least one of the short range communication protocols. The smart computing device is attached to the eyepiece of the microscope. The image is captured by activating an application installed on the smart computing device and is displayed in a split screen view. The user is enabled to focus the image and select the appropriate field of view using the split screen image. The smart computing device communicates with a robot attached to the control knobs of the microscope for focusing the image and selecting the appropriate field of view.

### CROSS-REFERENCE TO RELATED APPLICATIONS

The application is a National Phase Application filed with respect to the PCT Application No. PCT/IN2016/000240 filed on Oct. 3, 2016 with the title “SYSTEM AND METHOD FOR DIGITIZING SAMPLES UNDER A MICROSCOPE”, The application further claims the priority of the Indian Provisional Patent Application with No. 201641006265 filed on Feb. 23, 2016 the title “A SYSTEM AND A METHOD FOR CAPTURING MICROSCOPE IMAGES”. The contents of the above mentioned applications are incorporated in its entirety by reference herein.

### BACKGROUND

### Technical Field

The embodiments herein are generally related to optical instruments and imaging technology. The embodiments herein are particularly related to capturing of an image or a video, stage movement and focus control of a microscope. The embodiments herein are more particularly related to a system and method for capturing an enlarged image or video using microscope through a camera in a mobile phone and a mobile image processing application. The embodiments herein are especially related to a system and method for digitizing samples under the microscope.

### Description of the Related Art

In recent years, the smart computing devices have become an important part of the health care system with the ability to capture and analyse various clinically relevant images. The smart computing devices include smart phones, tablet devices, etc. The imaging, connectivity and processing capabilities of the smart computing devices are utilized for different medical applications including microscopic imaging, spectroscopy, quantifying diagnostic tests etc.

Typically, a smart phone is mounted on an eyepiece of an optical instrument. The optical instrument including the microscope magnifies or enhances the image of a specimen placed on a slide under the eyepiece. The smart phone mounted on the eyepiece enables to capture record and transmit the magnified and enhanced image for further processing. Unlike the digital cameras or scientific cameras used for quantitative optical imaging application having several adjustable parameters, such as ISO, exposure settings, white balance, colour temperature, etc., the smart phone does not provide adjustable parameters. The parameters of the smart phone cameras are adjusted automatically leading to non-uniform colour scheme for different images captured with the camera for the same slide. The variations in the images make the comparison by human viewers or automated analysis software a tedious job.

Further, the display screen of the smart computing device is smaller compared to different computational device. Therefore, the image captured on the display screen is insufficient to identify different areas and regions of interest and focus the image effectively. Further, the smart phone camera does not enable optical zooming of the image captured. Therefore, the focusing of the image is performed by digitally zooming the captured image. However, the digital zooming does not aid in increasing the resolution. The person operating the microscope has to zoom in and zoom out the image each time before capturing the image, in order to focus the image effectively. Further, the method becomes tedious for the person to adjust the movement along the X, Y and Z axis of the stage for capturing the different field of view while simultaneously adjusting the zoom in and zoom out of the image. The pathologist or technician or clinician follows different paths on the slides to capture various field of views (FOV)) for different conditions. They have to remember the various sections of the slides that are to be observed to capture the field of views (FOV)'s. Hence there is a need for a device to provide an efficient mechanism to decide on the path of the slide scan.

Hence, there is a need for an efficient system and method for capturing the images or videos through a microscope without losing quality and resolution. There is also a need to digitize samples under the microscope. Further, there is a need to efficiently focus the image and select an appropriate field of view using a smart computing device. Furthermore, there is a need to reduce efforts of the user thereby automating the stage movement of the microscope.

The above-mentioned shortcomings, disadvantages and problems are addressed herein and which will be understood by reading and studying the following specification.

### OBJECTS OF THE EMBODIMENTS

The primary object of the embodiments herein is to provide a method and system for capturing the magnified images or videos through a microscope by installing a microscopic imaging application on a smart computing device retrofitted to the microscope.

Another object of the embodiments herein is to provide a method and system for digitizing samples under a microscope.

Yet another object of the embodiments herein is to provide a method and system for automating a stage movement of a microscope by installing a microscopic imaging application on a smart computing device.

Yet another object of the embodiments herein is to provide a microscopic imaging application on a smart computing device to generate a split screen image to focus an area/region of interest under a microscope effectively.

Yet another object of the embodiments herein is to provide a microscopic imaging application on a smart computing device to generate one of a split screen image as a full field view for selecting an appropriate field of view.

Yet another object of the embodiments herein is to provide a microscopic imaging application on a smart computing device for generating one of a split screen view of a portion of the specimen, to focus on the image efficiently.

Yet another object of the embodiments herein is to provide a microscopic imaging application on a smart computing device to enable a user to capture an image with voice and gesture activated commands, thereby enabling the user to adjust the microscope setting for better image capture.

Yet another object of the embodiments herein is to provide a system and method for automating stage movement of a microscope by coupling a robotic attachment to the control knobs of the microscope

Yet another object of the embodiments herein is to provide a microscopic imaging application on a smart computing device capable of controlling a robotic attachment to automate stage movement of a microscope.

These and other objects and advantages of the embodiments herein will become readily apparent from the following detailed description taken in conjunction with the accompanying drawings.

### SUMMARY

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

The embodiments herein provide a system and method for digitizing samples under a microscope. The system and method enables capturing of images or videos of a specimen observed through the microscope, by efficiently focusing the image and selecting an appropriate field of view using a smart computing device. The smart computing device includes but is not limited to smart phone or a tablet device. The smart computing device is attached to an eyepiece of the microscope. The image is captured by activating a microscopic imaging application installed on the smart computing device. The microscopic imaging application is configured to direct the user to the camera of the smart computing device. Further, the microscopic imaging application displays the image in a split screen. The user is enabled to efficiently focus the image and select the appropriate field of view using the split screen image displayed on the screen of the smart computing device. The smart computing device communicates with a robot attached to the control knobs of the microscope for focusing the image and selecting the appropriate field of view.

According to an embodiment herein, a system for digitizing samples observed through a microscope is provided. The system comprising a microscope, a smart computing device, a smart computing device holder, a robotic attachment and a command interface. The microscope with a stage is configured to hold the sample. The sample is placed on the stage using a slide. The smart computing device is configured to capture an image or a video of a sample observed through an eyepiece of a microscope using a microscopic imaging application installed in the smart computing device. The microscopic imaging application enables a user to observe a split screen view of the image on a Graphical User Interface (GUI) of the smart computing device. The smart computing device holder is configured to position a camera in the smart computing device to obtain an optimal field of view through the eyepiece of the microscope. The smart computing device holder is configured to hold the smart computing device using a holder attached to the smart computing device holder. The robotic attachment is configured to adjust the movements of the stage for focusing the image observed through the camera based on the split screen view of the image. The robotic attachment comprises a plurality of robotic arms coupled to control knobs of the microscope for adjusting the movements of the microscopic stage. The command interface is configured to control the robotic attachment based on a plurality of control commands from the microscopic imaging application. The command interface comprises a communication module for receiving the plurality of control commands from the microscopic imaging application and a robot driver for controlling the robotic attachment.

According to an embodiment herein, the splits screen view of the image displayed on the smart computing device comprises a full field view and an enlarged view of the image.

According to an embodiment herein, the robotic attachment is configured to adjust the movements of the stage along the X, Y and Z-axis.

According to an embodiment herein, the robotic attachment adjusts the Z-axis movements of the stage based on the enlarged view of the image for focusing the image observed through the camera.

According to an embodiment herein, the robotic attachment adjusts the X-axis and Y-axis movements of the stage based on the full field view of the sample to select an area of interest.

According to an embodiment herein, the microscopic imaging application installed in the smart computing device further standardize quality of the image by adjusting a plurality of parameters of the camera selected from a group consisting of ISO, exposure settings, white balance, colour temperature, etc.

According to an embodiment herein, the smart computing device is further configured to capture the image displayed on the GUI using one of a touch input, a voice activated command and a gesture activated command.

According to an embodiment herein, the smart computing device holder adjusts the position of the camera by placing the smart computing device on the holder to automatically align the center of the camera with the center of the eyepiece.

According to an embodiment herein, the smart computing device holder further adjusts the position of the camera by moving the holder holding the smart computing device in forward and backward motion along a rail running through the smart computing device holder to adjust the distance of the camera from the eyepiece of the microscope.

According to an embodiment herein, the smart computing device is further configured to enable a user to initiate auto scan of the sample by pressing an auto scan button on the GUI of the smart computing device.

According to an embodiment herein, the smart computing device is further configured to store the captured images or videos.

According to an embodiment herein, the smart computing device is further configured to upload the captured images or videos to a cloud based storage device using an internet connection.

According to an embodiment herein, the communication module receives the plurality of control commands from the microscopic imaging application through short-range communication protocol.

According to an embodiment herein, the robotic attachment is further configured to adjust the objective lens of the microscope.

According to an embodiment herein, a method for digitizing samples observed through a microscope is provided. The method includes placing a slide holding a sample on a stage of the microscope by a user for capturing an image using a smart computing device. The method includes activating a microscopic imaging application installed on the smart computing device for capturing the image by the user. The microscopic imaging application displays a split screen view of the image on the Graphical User Interface (GUI) of the smart computing device. The method includes positioning a camera in the smart computing device with respect to an eyepiece of the microscope. The positioning of camera is performed using a smart computing device holder. The method includes entering an identification number and type of the sample on the slide in the microscopic imaging application. The method includes initiating an auto-scan of the sample by pressing/tapping on an auto-scan button displayed on the GUI of the smart computing device for capturing images or videos of the sample. The auto-scan of the sample is performed by the microscopic imaging application based on the type of the sample. The method includes filtering the captured images or videos based on a plurality of parameters by the microscopic imaging application. The plurality of parameters includes but is not limited to image properties including sharpness of the image, colour profile, brightness etc., and features of specimen including number of cells present in the field of view. The method includes completing the auto scan on capturing a predefined number of images or videos by the microscopic imaging application for each type of specimen. The method includes storing each captured image in the smart computing device with the identification number of the sample. The captured images or videos stored in the smart computing device are uploaded to a cloud based storage device.

According to an embodiment herein, the auto scan is performed using a scanning algorithm based on the type of the sample entered by the user.

According to an embodiment herein, the method further comprises controlling the stage movements of the microscope by sending control commands to a robotic attachment coupled to control knobs of the microscope by the microscopic imaging application on initiating auto scan.

According to an embodiment herein, an image or a video is captured.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

### BRIEF DESCRIPTION OF THE DRAWINGS

The other objects, features and advantages will occur to those skilled in the art from the following description of the preferred embodiment and the accompanying drawings in which:

FIG. 1A illustrates block diagram of a system for digitizing samples under a microscope by capturing the microscopic image using a smart computing device, according to one embodiment herein.

FIG. 1B illustrates block diagram of a system for digitizing samples under a microscope using a smart computing device, according to one embodiment herein.

FIG. 1C illustrates block diagram of electronic modules of a system for digitizing samples under a microscope using a smart computing device, according to one embodiment herein.

FIG. 1D illustrates block diagram of a graphical user interface of a smart computing device displaying a split screen view, according to one embodiment herein.

FIG. 1E illustrates the screenshot of a split screen view of a specimen under a microscope displayed on a graphical user interface of a smart computing device, according to one embodiment herein.

FIG. 1F illustrates a perspective view of a microscope fixed with a smart computing device attached to an eyepiece, according to one embodiment herein.

FIG. 1G illustrates a perspective view of a microscope fixed with a smart computing device and robot retrofitted with the microscope, according to one embodiment herein.

FIG. 2 illustrates a flowchart explaining a method for digitizing samples under a microscope in a manual mode using a smart computing device, according to one embodiment herein.

FIG. 3 illustrates a flowchart explaining a method for digitizing samples under a microscope in an automated mode using a smart computing device, according to one embodiment herein.

Although the specific features of the embodiments herein are shown in some drawings and not in others. This is done for convenience only as each feature may be combined with any or all of the other features in accordance with the embodiments herein.

### DETAILED DESCRIPTION OF THE EMBODIMENTS

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

The various embodiments herein provide a system and method for digitizing samples under a microscope. The system captures the images or videos of a specimen observed through the microscope, by efficiently focusing an image and selecting an appropriate field of view using a smart computing device. The smart computing device includes but is not limited to smart phone and tablets device. The smart computing device is attached to an eyepiece of the microscope. The image is captured by activating a microscopic imaging application installed on the smart computing device. The microscopic imaging application is configured to direct the user to the camera of the smart computing device. Further, the microscopic imaging application displays the image in a split screen. The user is enabled to efficiently focus the image and select the appropriate field of view using the split screen image displayed on the screen of the smart computing device. The smart computing device communicates with a robot attached to the control knobs of the microscope for focusing the image and selecting the appropriate field of view.

According to an embodiment herein, a system for digitizing samples observed through a microscope is provided. The system comprising a microscope, a smart computing device, a smart computing device holder, a robotic attachment and a command interface. The microscope with a stage is configured to hold the sample. The sample is placed on the stage using a slide. The smart computing device is configured to capture an image of a sample observed through an eyepiece of a microscope using a microscopic imaging application installed in the smart computing device. The microscopic imaging application enables a user to observe a split screen view of the image on a Graphical User Interface (GUI) of the smart computing device. The smart computing device holder is configured to position a camera in the smart computing device to obtain an optimal field of view through the eyepiece of the microscope. The smart computing device holder holds the smart computing device using a holder attached to the smart computing device holder. The robotic attachment is configured to adjust the movements of the stage for focusing the image observed through the camera based on the split screen view of the image. The robotic attachment comprises a plurality of robotic arms coupled to control knobs of the microscope for adjusting the movements of the microscopic stage. The command interface is configured to control the robotic attachment based on a plurality of control commands from the microscopic imaging application. The command interface comprises a communication module for receiving the plurality of control commands from the microscopic imaging application and a robot driver for controlling the robotic attachment.

According to an embodiment herein, the splits screen view of the image displayed on the smart computing device comprises a full field view and an enlarged view of the image.

According to an embodiment herein, the robotic attachment is configured to adjust the movements of the stage along the X (left-right), Y (top-bottom) and Z (up-down for focus) axis.

According to an embodiment herein, the robotic attachment adjusts the Z-axis movements of the stage based on the enlarged view of the image for focusing the image observed through the camera.

According to an embodiment herein, the robotic attachment adjusts the X-axis and Y-axis movements of the stage based on the full field view of the sample to select an area of interest.

According to an embodiment herein, the microscopic imaging application installed in the smart computing device further standardize quality of the image by adjusting a plurality of parameters of the camera selected from a group consisting of ISO, exposure settings, white balance, color temperature, etc.

According to an embodiment herein, the smart computing device is further configured to capture the image displayed on the GUI using one of a touch input, a voice activated command and a gesture activated command.

According to an embodiment herein, the smart computing device holder adjusts the position of the camera by placing the smart computing device on the holder to automatically align the center of the camera with the center of the eyepiece.

According to an embodiment herein, the smart computing device holder further adjusts the position of the camera by moving the holder holding the smart computing device in forward and backward motion along a rail running through the smart computing device holder to adjust the distance of the camera from the eyepiece of the microscope.

According to an embodiment herein, the smart computing device is further configured to enable a user to initiate auto scan of the sample by pressing an auto scan button on the GUI of the smart computing device.

According to an embodiment herein, the smart computing device is further configured to store the captured images or videos.

According to an embodiment herein, the smart computing device is further configured to upload the captured images or videos to a cloud based storage device using an internet connection.

According to an embodiment herein, the communication module receives the plurality of control commands from the microscopic imaging application through short-range communication protocol.

According to an embodiment herein, the robotic attachment is further configured to adjust the objective lens of the microscope.

According to an embodiment herein, a method for digitizing samples observed through a microscope is provided. The method includes placing a slide holding a sample on a stage of the microscope by a user for capturing an image using a smart computing device. The method includes activating a microscopic imaging application installed on the smart computing device for capturing the image by the user. The microscopic imaging application displays a split screen view of the image on the Graphical User Interface (GUI) of the smart computing device. The method includes positioning a camera in the smart computing device with respect to an eyepiece of the microscope. The positioning of camera is performed using a smart computing device holder. The method includes entering an identification number and type of the sample on the slide in the microscopic imaging application. The method includes initiating an auto-scan of the sample by pressing/tapping on an auto-scan button displayed on the GUI of the smart computing device for capturing images or videos of the sample. The auto-scan of the sample is performed by the microscopic imaging application based on the type of the sample. The method includes filtering the captured images or videos based on a plurality of parameters by the microscopic imaging application. The plurality of parameters includes but is not limited to image properties including sharpness of the image, colour profile, brightness etc and features of specimen including number of cells present in the field of view. The method includes completing the auto scan on capturing a predefined number of images or videos by the microscopic imaging application for each type of specimen. The method includes storing each captured image in the smart computing device with the identification number of the sample. The captured images or videos stored in the smart computing device are also uploaded to a cloud based storage device.

According to an embodiment herein, the auto scan is performed using a scanning methodology based on the type of the sample entered by the user.

According to an embodiment herein, the method further comprises controlling the stage movements of the microscope by sending control commands to a robotic attachment coupled to control knobs of the microscope by the microscopic imaging application on initiating auto scan.

According to an embodiment herein, a system for digitizing samples under a microscope by capturing a microscopic image using a smart computing device is provided. The system comprises a smart computing device, a microscope and a robot. The smart computing device is attached to an eyepiece of the microscope. The smart computing device comprises a microscopic imaging application installed for enabling the user to capture an image through the microscope. The smart computing device captures the image of a specimen kept on a stage under the eyepiece of the microscope. The robot is attached to control knobs of the microscope. The control knobs are configured to adjust a stage movement of the microscope and change a focus of the objective lens of the microscope.

Once the microscopic imaging application is activated, the user is directed to the camera of the smart computing device. The user is further enabled to configure the parameters of the camera to standardize an image quality. The image of a specimen as observed through the microscope is displayed on a graphical user interface of the smart computing device. The image is displayed as a split screen image comprising a full field view and an enlarged view of the specimen. The full field view of the specimen enables the user to select the appropriate field of view for capturing the image. Further, the enlarged image enables the user to focus the image for capturing the image. The appropriate field of view is adjusted by moving the stage of the microscope. The stage movement is performed by providing a command to the robot for controlling the control knobs. The commands are provided by the user through the microscopic imaging application on the smart computing device. The smart computing device acts as a controller of the robot. Once the appropriate field of view is identified and the image is focused, the user is enabled to capture the image through voice/gesture activated commands provided through the microscopic imaging application on the smart computing device.

According to an embodiment herein, a method for capturing the microscopic image using a smart computing device is provided. The method comprises activating a microscopic imaging application installed on a smart computing device. The smart computing device is attached to the eyepiece of a microscope. Once the application is activated, a user is directed to select an image capture mode of the smart computing device. The user is enabled to capture a plurality of images or videos of a specimen kept on a stage under the microscope. The user is enabled to adjust the optical parameters of the camera for standardizing the image quality of a plurality of images or videos captured by the smart computing device. Further, the image is focused by the user. The image is displayed as a split screen view on a graphical user interface (GUI) of the smart computing device. The split screen view includes both a full field view and an enlarged field of view of displayed simultaneously on the GUI. The enlarged view of the image enabled the user to adjust the focus. Further, the full field view enables the user to select the area of interest. The user is enabled to adjust the stage to select the area of interest and adjust the focus. The stage is adjusted based on the user specific commands sent from the microscopic imaging application on the smart computing device. Once the area of interest is selected and image is focused, the user is further enabled to provide commands to click the image with voice/gesture activated commands.

According to an embodiment herein, the system for automating the stage movement of the microscope is provided. The system comprises a smart computing device, a microscope and a robot. The smart computing device and the robot are retrofitted to the microscope. The smart computing device is attached to an eyepiece of the microscope. The robot is configured to adjust the stage movements based on the commands received on a command interface of the robot. A user is enabled to provide the user specific commands through a mobile application installed on the smart computing device. The smart computing device acts as an external computing device for providing commands to the robot. The smart computing device communicates with the robot using wireless or wired communication. The robot is attached to the control knobs of the microscope by a coupling mechanism. The control knobs are configured to adjust the movements along X, Y and Z axis of a stage. The stage is a platform on which the object to be viewed through the microscope is placed. The robot comprises a first arm, a second arm, a third arm and a fourth arm. The first arm, second arm and the third arm are attached to the control knobs to adjust the X, Y and Z movements respectively based on the commands received from the smart computing device. The fourth arm is configured to change the focus of the objective lens of the microscope.

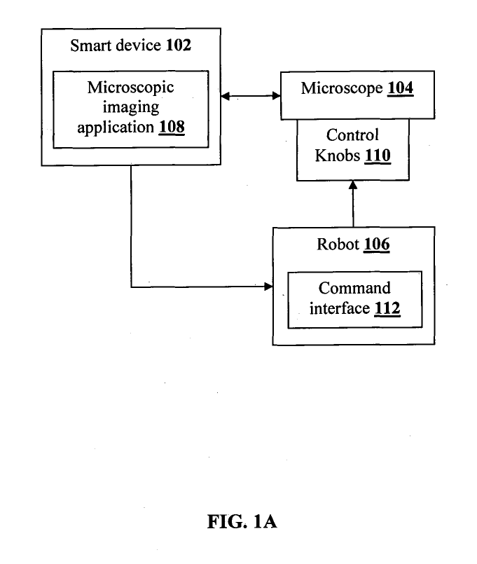

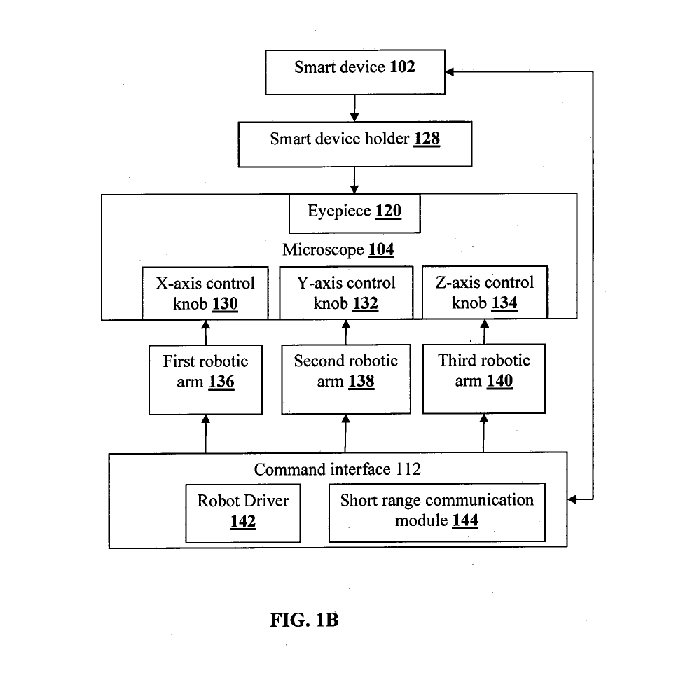

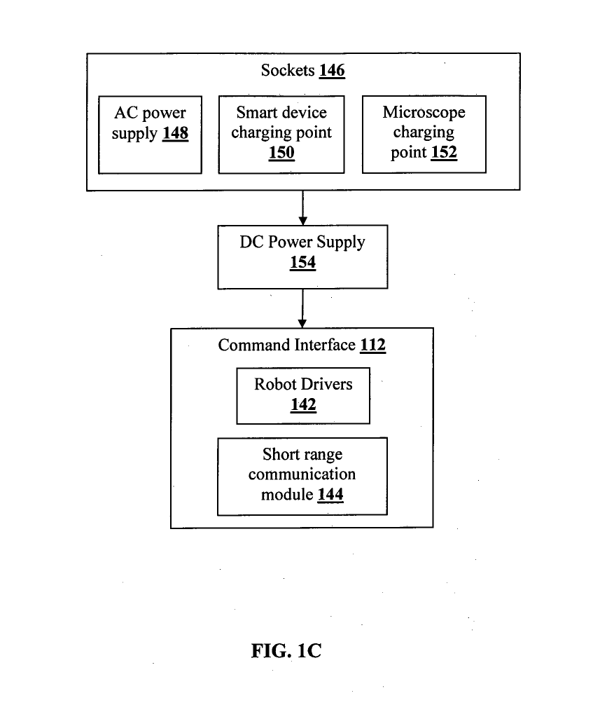

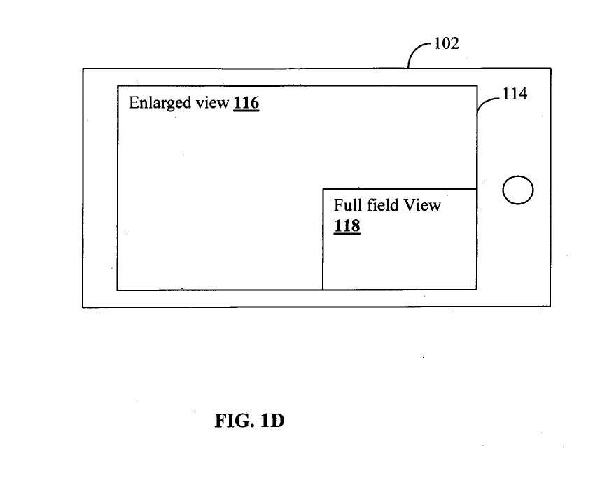

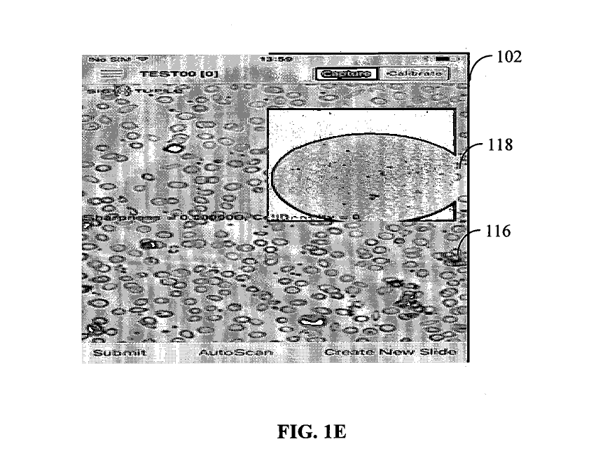

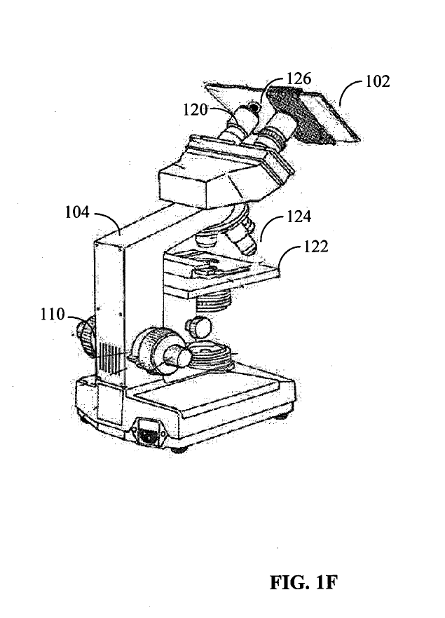

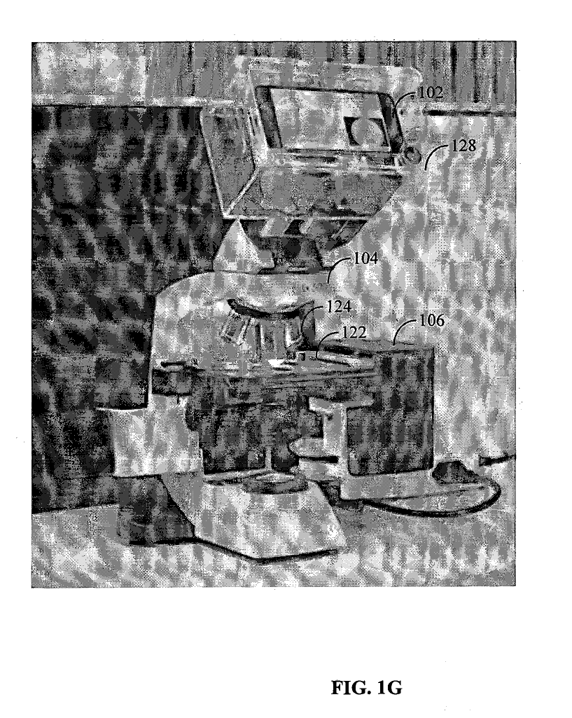

FIG. 1A illustrates block diagram of a system for digitizing samples under a microscope by capturing the microscopic image using a smart computing device, according to one embodiment herein. FIG. 1B illustrates block diagram of a system for digitizing samples under a microscope using a smart computing device, according to one embodiment herein. FIG. 1C illustrates block diagram of electronic modules of a system for digitizing samples under a microscope using a smart computing device, according to one embodiment herein. FIG. 1D illustrates block diagram of a graphical user interface of a smart computing device displaying a split screen view, according to one embodiment herein. FIG. 1E illustrates the screenshot of a split screen view of a specimen under a microscope displayed on a graphical user interface of a smart computing device, according to one embodiment herein. FIG. 1F illustrates a perspective view of a microscope fixed with a smart computing device attached to an eyepiece, according to one embodiment herein. FIG. 1G illustrates a perspective view of a microscope fixed with a smart computing device and robot retrofitted with the microscope, according to one embodiment herein.

With respect to FIG. 1A-1G, a system for digitizing a specimen under a microscope is provided. The system enables capturing of a microscopic image using a smart computing device. The system comprises a smart computing device 102, a microscope 104, and a robot 106. The smart computing device 102 includes but is not limited to a mobile phone, a smart phone, a tablet etc. The smart computing device 102 comprises a microscopic imaging application 108 installed on the smart computing device 102. The smart computing device 102 comprises an inbuilt camera 126 for capturing the images or videos. The camera 126 of the smart computing device 102 is attached to the eyepiece 120 of the microscope 104 using a smart computing device holder 128.

The smart computing device holder 128 is cuboidal in shape and fits over either one or both eyepiece of the microscope 104. The smart computing device holder 128 comprises a holder capable of holding the smart computing device 102. The smart computing device holder 128 enables the user to bring the camera 126 and the eyepiece 120 in proper alignment. The holder on the smart computing device holder 128 aligns the center of the camera 126 and the center of the eyepiece 120 automatically. The smart computing device holder 128 further enables a user to position the camera 126 at a proper distance away from the eyepiece 120 of the microscope 104. In order to achieve proper distance, the holder on the smart computing device holder 128 is moved forward and backward along a rail running through the smart computing device holder 128. The user is enabled to move the holder forward and backward by turning a knob provided on the smart computing device holder 128.

Therefore, the smart computing device holder 128 enables to adjust the position of camera 126 to obtain an optimal field of view. Further, on using a different smart computing device or a different model of the same smart computing device 102, the user is enabled to change the holder on the smart computing device holder 128. The user is enabled to choose a holder according to the dimensions of the new model of smart computing device 102. Therefore, the smart computing device holder 128 is capable of holding smart computing device 102 of any model.

The camera 126 is capable of enhancing the image of a specimen observed through the microscope 104. The specimen is placed on a stage 122 of the microscope 104. The stage 122 of the microscope 104 is adjusted by regulating the control knobs 110 of the microscope 104. The control knobs 110 include an X-axis control knob 130, a Y-axis control knob 132, and a Z-axis control knob 134. The X-axis control knob 130 is configured to adjust the movement of the stage 122 along the X-axis from left to right. The Y-axis control knob 132 is configured to adjust the movement of the stage 122 along the Y-axis in upward and downward direction. The Z-axis control knob 134 is configured to adjust the movement of the stage 122 along the Z-axis to focus the image observed through the camera 126 of the smart computing device 102.

The control knobs 110 of the microscope are coupled to a robot 106. The robot 106 comprises a first robotic arm 136, a second robotic arm 138, a third robotic arm 140 and a fourth robotic arm. The first robotic arm 136 is coupled to the X-axis control knob 130 for controlling X-axis movement of the stage 122. The second robotic arm 138 is coupled to the Y-axis control knob 132 for controlling Y-axis movement of the stage 122. The third robotic arm 140 is coupled to the Z-axis control knob 134 for controlling Z-axis movement of the stage 122. The fourth robotic arm is configured to change the objective lens 124 of the microscope 104.

Further, the user activates the microscopic imaging application 108 to capture the microscopic image using the smart computing device 102. Once the microscopic imaging application 108 is activated, the user is directed to the camera 126 of the smart computing device 102. The image of the specimen placed on the stage 122 is captured through the camera 126 and displayed on a graphical user interface of the smart computing device 102. The quality of the image displayed is standardized by adjusting the multiple parameters of the camera 126 using operating system capabilities of the smart computing device 102. The multiple parameters of the camera 126 includes but are not limited to ISO, exposure settings, white balance, color temperature, etc. The values of multiple parameters of the camera 126 are adjusted depending on the type of slide holding the specimen placed on the stage 122 of the microscope 104. For example, the values of the multiple parameters for a slide holding a specimen of peripheral blood smear is different from the values for a slide holding a specimen of urine. The change in the values of the multiple parameters is due to various factors including density of the cells on the slide, whether the slide is stained or unstained etc.

The image captured by the camera is displayed as a split screen view 114 on the graphical user interface of the smart computing device 102 as shown in FIG. 1D. FIG. 1E depicts a screen shot of a split screen view of an image as observed on the display of the smart computing device 102. The split screen view 114 includes a full field view 118 and an enlarged view 116 of the specimen. The full field view 118 of the specimen enables the user to select the area of interest by controlling the X and Y-axis movements of the stage 122. Further, the enlarged view 116 enables the user to adjust the focus by controlling the Z-axis movement of the stage 122. The X, Y and Z-axis movement of the stage 122 are controlled by providing control commands to the robot 106 to regulate the control knobs 110.

The robot 106 receives the commands on a command interface 112 from the smart computing device 102. The command interface 112 is an electronic module comprising a robot driver 142 and a communication module 144. The command interface 112 communicates with the smart computing device 102 through the communication module 144. The user is enabled to send the user specific commands to control the stage movement through the microscopic imaging application 108 on the smart computing device 102. The smart computing device 102 acts as an external controller for the robot 106. The smart computing device 102 communicates with the robot 106 through multiple wired and wireless communications. The wireless communications includes but are not limited to Wifi, Bluetooth, Bluetooth Low Energy (BLE), Long-Term Evolution (LTE), LTE-Advanced, Near Field Communication (NFC) etc. The wired communications includes but are not limited to USB, Ethernet, audio cable etc. The robot driver 142 in the robot 106 controls the robotic arms based on the commands received on the control interface 112. The robot driver 142 controls the first robotic arm 136, the second robotic arm 138, and the third robotic arm 140 to adjust the X-axis control knob 130, a Y-axis control knob 132, and an Z-axis control knob 134 respectively based on the commands. Further, the robot driver 142 controls the fourth robotic arm to control a knob to change the objective lens 124 of the microscope 104. The command set received by the robot 106 include but are not limited to the commands provided in the table below:

| Robotic | |
|---|---|
| arms | Commands |
| First | Move in +X direction by x degrees: rotates the X-axis knob |
| robotic | of the microscope stage in the positive direction by a specified |
| arm | angle using the robotic arm |
| | Move in −X direction: rotates the X-axis knob of the |
| | microscope stage in the negative direction by a specified angle |
| | using the robotic arm |
| Second | Move in +Y direction: rotates the Y-axis knob of the |
| robotic | microscope stage in the positive direction by a specified angle |
| arm | using the robotic arm |
| | Move in −Y direction: rotates the Y-axis knob of the |
| | microscope stage in the negative direction by a specified angle |
| | using the robotic arm |
| Third | Move in +Z direction: rotates the Z-axis knob of the |
| robotic | microscope stage in the positive direction by a specified angle |
| arm | using the robotic arm. The rotation in +Z direction is used for |
| | adjusting focus. |
| | Move in −Z direction: rotates the Z-axis knob of the |
| | microscope stage in the negative direction by a specified angle |
| | using the robotic arm, The rotation in −Z direction is used for |
| | adjusting focus. |
| Fourth | Rotate Objective Lens Assembly Clockwise: moves the |
| robotic | object lens assembly through a specific angle in the clockwise |
| arm | direction so that the next lens in that direction becomes the |
| | active lens. |
| | Rotate Objective Lens Assembly Anti-Clockwise: moves |
| | the object lens assembly through a specific angle in the anti- |
| | clockwise direction so that the next lens in that direction |
| | becomes the active lens. |

Thus, the user is enabled to provide the user specific commands to adjust the field of view and to focus the image. The commands are pre-configured in the microscopic imaging application 108 of the smart computing device 102 or provided by the user in real time. The smart computing device 102 communicates with the control interface 112 of the robot 106 to adjust the slide in the around the X and Y-axis directions, thereby adjusting the field of view of the image. The field of view is further selected as the area of interest. The criteria for selecting the area of interest includes is predetermined or specified by the user. Further, the smart computing device 102 is configured to identify the regions of the image to be scanned. The camera 126 of the smart computing device 102 is checked to identify whether the image lies/is in the focus of the camera lens and adjust the Z-axis movement of the stage 122 through the microscopic imaging application 108 for focusing the image. The smart computing device 102 is configured to identify the required magnification for capturing the image and is capable of changing the objective lens 124 of the microscope with the robot 106.

Once the image quality is standardized and the image is perfectly focused, the user is enabled to capture the image displayed on the GUI through any one of voice and gesture activated commands. The microscopic imaging application 108 installed on the smart computing device 102 is capable of recognizing the voice and gesture activated commands to capture the image. The microscopic imaging application 108 configures the in built microphone in the smart computing device 102 to identify the voice-activated commands. The voice commands including ‘CAPTURE IMAGE’, ‘CLICK’ etc., provided by the user is identified by the microscopic imaging application 108 to capture the image. Further, the microscopic imaging application 108 configures the front camera inbuilt on the smart computing device 102 to identify the gesture-activated commands. The gesture activated commands including but not limited to ‘Blinking of the eyes for a predefined number of times’, provided by the user is identified by the microscopic imaging application 108 to capture the image. Thus, the user is enabled to capture images or videos through the microscope with the smart computing device 102.

Further, FIG. 1C depicts the electronic modules providing power supply to the components of the system. The smart computing device 102 is plugged into a smart computing device charging point 150 in a socket 146. The socket 146 receives power from an AC power supply 148. The smart computing device 102 receives electric power from the smart computing device charging point 150 for charging the battery of the smart computing device. Further, the microscope 104 is plugged into a microscope charging point 152 in the socket 146. The microscope 104 receives electric power through the microscope charging point 152.

Further, the AC power supply 148 is converted to a DC power supply 154. The DC power supply 154 provides electric power to the robot driver 142 and the short-range communication module 144 in the command interface 112. The command interface 112 is a printed circuit board holding the electronic components in the robot driver 142 and the short-range communication module 144.

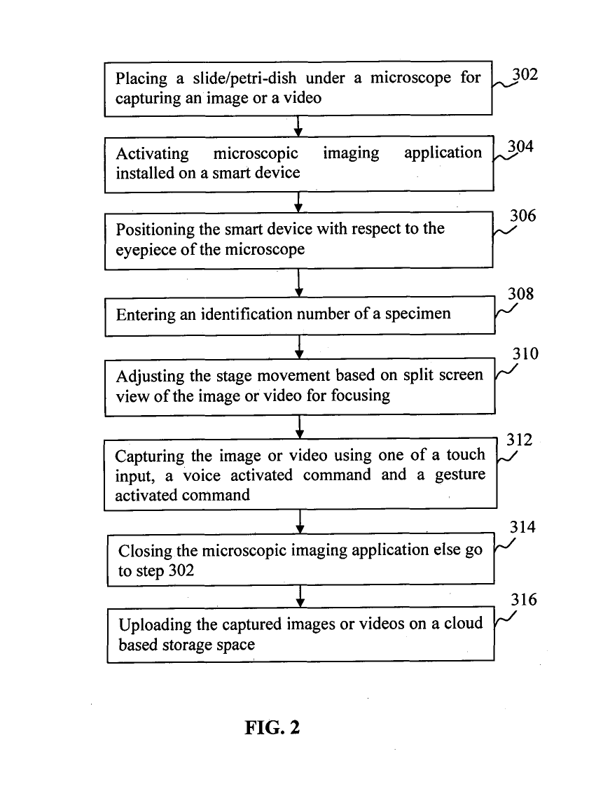

FIG. 2 illustrates a flowchart explaining a method for digitizing samples under a microscope in a manual mode using a smart computing device, according to one embodiment herein. The method includes placing a specimen under a microscope for capturing an image using a smart computing device (302). A microscopic imaging application installed on the smart computing device is activated for capturing the image (304).

Further, the smart computing device is positioned with respect to the eyepiece of the microscope (306). The smart computing device is placed on a smart computing device holder that fits over either one or both eyepiece of the microscope. The smart computing device holder comprises a holder capable of holding the smart computing device. The smart computing device holder enables a user to position the camera at a proper distance away from the eyepiece of the microscope. The smart computing device holder further enables the user to bring the camera and the eyepiece in proper alignment by moving the holder forward and backward along a rail running through the smart computing device holder.

An identification number of the specimen is entered by a user (308). The microscopic imaging application associates each captured image of the specimen with the identification number for future reference. On activating the microscopic imaging application, the user is directed to a camera of the smart computing device. The user is enabled to observe the image of the specimen on a Graphical User Interface (GUI) of the smart computing device as observed through the eyepiece of the microscope. The user is enabled to observe the image of a specimen as a spit screen view of the image.

The user is enabled to adjust the stage movement of the microscope based on split screen view of the image for focusing the image (310). The split screen view comprises a full field view and an enlarged view. The full field view enables the user to select the area of interest by controlling the X and Y-axis movements of the stage. Further, the enlarged view enables the user to adjust the focus by controlling the Z-axis movement of the stage. In the manual mode, the X, Y and Z-axis movement of the stage is adjusted by manually controlling the control knobs on the microscope. Once the user selects the area of interest and focus the image, the user is enabled to capture the image using the smart computing device. The method includes capturing the image using one of a touch input, a voice activated command and a gesture activated command (312). Further, the user is enabled to repeat steps 310 and 312 to capture multiple images or videos of the specimen by selecting different area of interest.

The user is enabled to capture images or videos of different specimen by repeating the steps from 302 or else closing the microscopic application once the required number of images or videos of the specimen is captured (314). The captured images or videos are stored temporarily on the smart computing device. Further, the captured images or videos are uploaded to a cloud based storage device using an internet connection on the smart computing device (316).

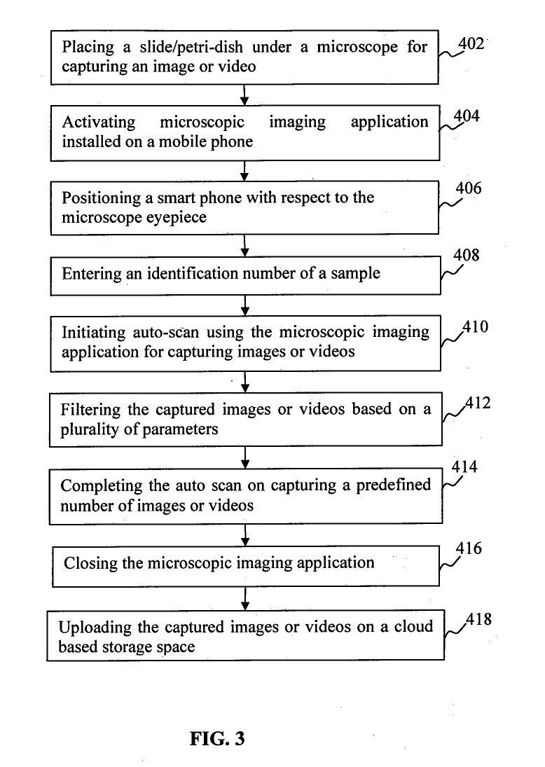

FIG. 3 illustrates a flowchart explaining a method for digitizing samples under a microscope in an automated mode using a smart computing device, according to one embodiment herein. The method includes placing a specimen under a microscope for capturing an image using a smart computing device (402). The specimen is placed in a stage of a microscope. A microscopic imaging application installed on the smart computing device is activated for capturing the image (404).

Further, the smart computing device is positioned with respect to the eyepiece of the microscope (406). The smart computing device is placed on a smart computing device holder that fits over either one or both eyepiece of the microscope. The smart computing device holder comprises a holder capable of holding the smart computing device. The smart computing device holder enables a user to position the camera at a proper distance away from the eyepiece of the microscope. The smart computing device holder further enables the user to bring the camera and the eyepiece in proper alignment by moving the holder forward and backward along a rail running through the smart computing device holder.

An identification number of the specimen is entered/input by a user (408). The microscopic imaging application associates each captured image of the specimen with the identification number for future reference. Further, the user is enabled to enter the type of the specimen placed on the slide. The microscopic imaging application in the smart computing device is configured to scan the slide using a scanning algorithm based on the type of the specimen. For example, the microscopic imaging application uses different scanning algorithm for scanning specimen including blood, urine, semen, bacteria culture and the like.

An auto-scan process is initiated using microscopic imaging application for capturing images or videos of the specimen (410). The auto-scan is initiated by pressing/tapping on an auto-scan button displayed on the GUI of the smart computing device with microscopic imaging application. The microscopic imaging application is configured to initiate auto scan using a scanning algorithm based on the type of the specimen entered by the user. The microscopic imaging application is run on the smart computing device and configured to automatically control the stage movements of the microscope by sending control commands to a robot coupled to the microscope to control the knobs of the microscope. The control knobs adjust the movements of the stage along X, Y and Z axis based on the control commands. The control commands are issued to control a movement of the microscope stage horizontally along the left-right directions and vertically top-bottom directions. In addition to these movements, the control commands are issued to control the focus knob through the robotic attachment to adjust the focus levels in each field of view to a plurality of focus levels. The application is configured to determine the direction of motion of the focus knob to improve the focus and keep moving the knob in the same direction till the focus of the image is improved and a well-focussed image is obtained. Thus the application is run and configured to capture well focussed images or videos at each field of view.

The microscopic imaging application is configured to send the control commands to the robot using a short-range communication protocol. The short-range communication protocol includes but is not limited to Bluetooth, infrared, near field communication, Wi-Fi and Zigbee and the like. The method includes capturing multiple images or videos using multiple focus levels at each field of view.

Further, the captured images or videos are filtered based on a plurality of parameters (412). Each captured image or video of the specimen is checked against the plurality of parameters. The plurality of parameters includes but is not limited to image properties including sharpness of the image, colour profile, brightness etc and features of specimen including number of cells present in the field of view. The quality of the plurality of parameters for each captured image is checked to decide a plurality of factors. A first factor decided includes whether to change the focus and capture another image at the same field of view. A second factor includes to decide whether to ignore the field of view displayed on the GUI. Further, a third factor includes whether to save the field of view as an acceptable image and move to a different field of view.

An auto scan process is initiated after capturing a predefined number of images or videos (414). The microscopic imaging application is configured to capture a predefined number of images or videos for each type of specimen. The auto scanning is automatically completed once the microscopic imaging application is configured to capture the predefined number of images or videos. Further, the user is also enabled to stop the auto scan before capturing the predefined number of images or videos by pressing/tapping on the auto scan button on the display screen of the smart computing device.

The user is enabled to close the microscopic imaging application on the smart computing device or to capture images or videos of a second specimen by following the steps from 408 (416). The captured images or videos are stored temporarily on the smart computing device. Further, the captured images or videos are uploaded to a cloud based storage device using an internet connection on the smart computing device (418).

The embodiments herein envisages a system and method for capturing the image view through a microscope using a smart computing device. The system displays the image to be captured on the graphical user interface as a split screen view. Therefore, the image is displayed as a full field view and an enlarged view simultaneously on the same GUI, thereby enabling the user to select a region of interest and focus a portion on the region with ease. Further, the image is captured using voice or gesture activated commands. The user need not touch the GUI for capturing the image. Therefore, the hands of the user are freed from the purpose of capturing the image, thereby enabling the user to adjust the stage movement and focus. The user need not do multiple task at the same time, rather is enabled to concentrate on adjusting the stage movement and focusing the image.

The system further enables the stage movement for slide scanning using the existing control knobs of the microscope by coupling a robot. Therefore, the system is enabled to provide low cost hardware for slide scanning compared to the existing slide scanning systems.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

Although the embodiments herein are described with various specific embodiments, it will be obvious for a person skilled in the art to practice the invention with modifications. However, all such modifications are deemed to be within the scope of the claims.

It is also to be understood that the following claims are intended to cover all of the generic and specific features of the embodiments described herein and all the statements of the scope of the embodiments which as a matter of language might be said to fall there between.

What is claimed is:

1. A system for digitizing samples observed through a microscope, the system comprising:
a microscope with a stage configured to hold the sample, wherein the sample is placed on the stage using a slide or petri dish;
a smart computing device configured to capture an image or a video of a sample observed through an eyepiece of a microscope using a microscopic imaging application installed in the smart computing device, wherein the microscopic imaging application enables a user to observe a split screen view of the image on a Graphical User Interface (GUI) of the smart computing device;
a smart computing device holder configured to position a camera in the smart computing device to obtain an optimal field of view through the eyepiece of the microscope, wherein the smart computing device holder is configured to hold the smart computing device;
a robotic attachment configured to adjust the movements of the microscope stage and a focusing of the image observed through the camera based on the split screen view of the image, wherein the robotic attachment comprises a plurality of robotic arms coupled to control knobs of the microscope for adjusting the movements of the microscopic stage; and
a command interface configured to control the robotic attachment based on a plurality of control commands from the microscopic imaging application, wherein the command interface comprises a communication module for receiving the plurality of control commands from the microscopic imaging application and a robot driver for controlling the robotic attachment.

2. The system according to claim 1, wherein the splits screen view of the image displayed on the smart computing device comprises a full field view and an enlarged view of the image.

3. The system according to claim 1, wherein the robotic attachment is configured to adjust a movement of the stage along the X, Y and Z-axis.

4. The system according to claim 1, wherein the robotic attachment adjusts the movement of the stage along Z-axis based on the enlarged view of the image for focusing the image observed through the camera.

5. The system according to claim 1, wherein the robotic attachment adjusts the X-axis and Y-axis movements of the stage based on the full field view of the sample to select an area of interest.

6. The system according to claim 1, wherein the microscopic imaging application installed in the smart computing device further standardize quality of the image by adjusting a plurality of parameters of the camera selected from a group consisting of ISO, exposure settings, white balance, colour temperature, sharpness, clarity, and colour balance.

7. The system according to claim 1, wherein the smart computing device is further configured to capture the image displayed on the GUI using one of a touch input, a voice activated command and a gesture activated command.

8. The system according to claim 1, wherein the smart computing device holder adjusts the position of the camera by placing the smart computing device on the holder to automatically align the center of the camera with the center of the eyepiece.

9. The system according to claim 1, wherein the smart computing device holder further adjusts the position of the camera by moving the holder configured to hold the smart computing device in forward and backward motion along a rail running through the smart computing device holder to adjust the distance of the camera from the eyepiece of the microscope.

10. The system according to claim 1, wherein the smart computing device is further configured to enable a user to initiate auto scan of the sample by pressing an auto scan button on the GUI of the smart computing device.

11. The system according to claim 1, wherein the smart computing device is further configured to store the captured images or videos

12. The system according to claim 1, wherein the smart computing device is further configured to upload the captured images or videos to a cloud based storage device using an internet connection.

13. The system according to claim 1, wherein the communication module receives the plurality of control commands from the microscopic imaging application through short-range communication protocol.

14. The system according to claim 1, wherein the commands to the imaging application is triggered from a remote place or remote location through a web API thereby enabling a user to view the field of capture remotely while manually controlling the imaging application.

15. The system according to claim 1, wherein the imaging application is configured to relay the user's command of capture, movement, and focus control, to the robotic attachment via short-range communication protocol.

16. The system according to claim 1, wherein the robotic attachment is further configured to adjust the objective lens of the microscope.

17. A method for digitizing samples observed through a microscope, the method comprises:
placing a slide holding a sample on a stage of the microscope by a user for capturing an image using a smart computing device;
activating a microscopic imaging application installed on the smart computing device for capturing the image by the user, wherein the microscopic imaging application displays a split screen view of the image on the Graphical User Interface (GUI) of the smart computing device;
positioning a camera in the smart computing device with respect to one or more eyepieces of the microscope, wherein the positioning of camera is performed using a smart computing device holder,
entering an identification number and type of the sample on the slide in the microscopic imaging application;
initiating an auto-scan of the sample by pressing/tapping on an auto-scan button displayed on the GUI of the smart computing device for capturing images or videos of the sample, wherein the auto-scan of the sample is performed by the microscopic imaging application based on the type of the sample by controlling microscopic stage movement and focus at each field of view via the robotic attachment;
filtering the captured images or videos based on a plurality of parameters by the microscopic imaging application, wherein the plurality of parameters includes image properties comprising sharpness of the image, colour profile, brightness and features of specimen including number of cells present in the field of view;
completing the auto scan on capturing a predefined number of images or videos by the microscopic imaging application for each type of specimen; and
storing each captured image in the smart computing device with the identification number of the sample, wherein the captured images or videos stored in the smart computing device are uploaded to a cloud based storage device.

18. The method according to claim 17, wherein the auto scan is performed using a scanning algorithm based on the type of the sample entered by the user and a pattern of scan selected by the user.

19. The method according to claim 17, wherein the method further comprises controlling the stage movements of the microscope by sending control commands to a robotic attachment coupled to control knobs of the microscope by the microscopic imaging application on initiating auto scan.
